(19) United States
(12) Patent Application Publication
(10) Pub. No.: US 2013/0103781 A1
(43) Pub. Date: Apr. 25, 2013

(54) MOBILE COMMUNICATION DEVICE

(71) Applicants: Yoshihiko Mori, Tokyo (JP); Takeshi Mitsui, Tokyo (JP); Hideki Fukuhara, Tokyo (JP); Yoshio Todoroki, Tokyo (JP)

(72) Inventors: Yoshihiko Mori, Tokyo (JP); Takeshi Mitsui, Tokyo (JP); Hideki Fukuhara, Tokyo (JP); Yoshio Todoroki, Tokyo (JP)

(73) Assignee: MITSUBISHI ELECTRIC CORPORATION, Tokyo (JP)

(21) Appl. No.: 13/699,473

(22) PCT Filed: Jul. 13, 2010
(86) PCT No.: PCT/JP2010/004521

§ 371 Date: Nov. 21, 2012

(51) Int. Cl. G06F 15/167

(52) U.S. Cl. CPC G06F 15/167
USPC 709/213

(57) ABSTRACT

A mobile communication device is mounted on a vehicle, and has a reception unit for receiving a distributed cache that is data having divided information, a distributed cache restoration unit for restoring the distributed cache into original information, a data dividing unit for producing the distributed cache by dividing the information, and a transmission unit for transmitting the distributed cache.

### TECHNICAL FIELD

The present invention relates to a mobile communication device for performing communications between mobile entities such as vehicles.

### BACKGROUND ART

In order to provide safe driving support information for ensuring more safety in driving a vehicle and entertainment information, studies have been made of an inter-vehicle communication device for transmitting/receiving information between nearby vehicles (for example, see Patent Document 1).

### PRIOR ART DOCUMENTS

### Patent Documents

Patent Document 1: Japanese Patent Application Publication No. 2010-87733 (page 2 and FIG. 1)

### SUMMARY IN THE INVENTION

### Problems to be Solved by the Invention

When communication of large multimedia data such as audio data or video data in music or movies is performed in the aforementioned inter-vehicle communication device, the occurrence of a communication error may possibly be increased due to a concentration of communication traffic to a specific vehicle or an increase of communication traffic volume.

The present invention is made to solve such a problem and a project of the invention is to provide a mobile communication device which is capable of performing a load balancing of the communication traffic and reducing the occurrence of the communication error even when large data communication is carried out.

### Means for Solving the Problems

A mobile communication device according to the invention is mounted on a vehicle, and has a reception unit for receiving a distributed cache that is data having divided information, a distributed cache restoration unit for restoring the distributed cache into original information, a data dividing unit for producing the distributed cache by dividing the information, and a transmission unit for transmitting the distributed cache.

### Effect of the Invention

According to the invention, the occurrence of a communication error can be reduced even when large data communication is carried out.

### BRIEF DESCRIPTION OF THE DRAWINGS

FIG. 1 is a schematic diagram showing a mobile communication system employing inter-vehicle communication according to Embodiment 1 in the present invention.

FIG. 2 is a block diagram showing a configuration of a mobile communication device according to Embodiment 1 in the invention.

FIG. 3 is a configuration diagram showing distributed caches transmitted/received between the mobile communication devices according Embodiment 1 in the invention.

FIG. 4 is a schematic diagram showing a state of exchange of surrounding vehicle information in the mobile communication system according to Embodiment 1 in the invention.

FIG. 5 is a flowchart showing reception processing of a distributed cache in the mobile communication device according to Embodiment 1 in the invention.

FIG. 6 is a flowchart showing reception processing of the distributed cache in a mobile communication device according to Embodiment 2 in the invention.

FIG. 7 is a schematic diagram showing a relationship between priority and transmission/reception of a distributed cache in a mobile communication system according to Embodiment 3 in the invention.

FIG. 8 is a schematic diagram showing a state of transmission/reception of the distributed caches in the mobile communication system according to Embodiment 3 in the invention.

FIG. 9 is a flowchart showing transmission processing of the distributed cache in the mobile communication device according to Embodiment 3 in the invention.

FIG. 10 is a schematic diagram showing a state of transfer of a distributed cache in a mobile communication system according to Embodiment 4 in the invention.

FIG. 11 is a schematic diagram showing a relationship among priority, data length, and transmission/reception of distributed caches in a mobile communication system according to Embodiment 5 in the invention.

FIG. 12 is a flowchart showing a changing procedure of a transmission rate in a mobile communication device according to Embodiment 6 in the invention.

### BEST MODE FOR CARRYING OUT THE INVENTION

### Embodiment 1

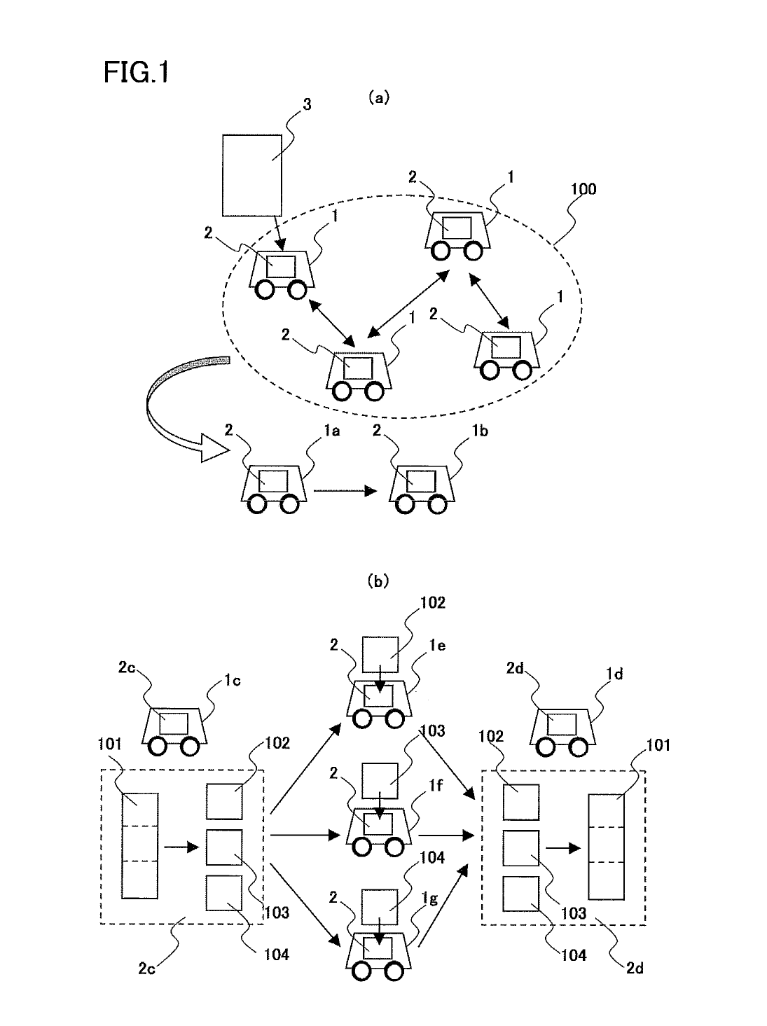

FIG. 1 is a schematic diagram showing a mobile communication system employing inter-vehicle communication according to Embodiment 1 in the present invention. FIG. 1(a) is a schematic diagram showing a state of transmission/reception of data in the mobile communication system employing the inter-vehicle communication according to Embodiment 1 in the invention, and FIG. 1(b) is a schematic diagram showing a state in which data is distributed and held in the mobile communication system using the inter-vehicle communication according to Embodiment 1 in the invention. In the drawings, components assigned with the same reference numerals are similar ones or equivalents thereto, and this applies to the entire description in common.

As shown in FIG. 1(a), in the mobile communication system according to Embodiment 1 in the invention, mobile communication devices 2 mounted on vehicles 1 that are mobile entities existing within an inter-vehicle communication network 100 mutually transmit/receive data with each other by direct communication with a P2P (Peer to Peer) protocol (method). A vehicle 1a is the vehicle 1 going out of the inter-vehicle communication network 100, while a vehicle 1b is a vehicle 1 that is located at a position geographically remote from the inter-vehicle communication network 100. An information transmission device 3 is installed on a road and the like to transmit information by using the same communication protocol as the mobile communication devices 2 mounted on the vehicles 1.

As shown in FIG. 1(b), in the mobile communication system according to Embodiment 1 in the invention, a mobile communication device 2c of a vehicle 1c holds original information (data) 101 such as safe driving support information or entertainment information. Vehicles 1e, 1f, 1g constitute a group of vehicles for relaying the information, and respective mobile communication devices 2 of the vehicles 1e, 1f, 1g possess distributed caches 102, 103, 104 which are the data obtained by dividing the original information and each correspond to a part of the original information. The distributed caches 102, 103, 104 held by the mobile communication devices 2 of the vehicles 1e, 1f, 1g are mutually different, and the original information 101 can be restored by combining the distributed caches 102, 103, 104 respectively held by the vehicles 1e, 1f, 1g. A vehicle 1d is the vehicle 1 desiring to acquire the original information 101. It is configured that in the mobile communication system shown in FIG. 1(b), the mobile communication device 2c of the vehicle 1c holds the original information 101 and distributes the distributed caches 102, 103, 104 to the mobile communication devices 2 of the vehicles 1e, 1f, 1g; however, the information transmission device 3 shown in FIG. 1(a) may hold the original information 101 and distributes the distributed caches 102, 103, 104 to the mobile communication devices 2 of the vehicles 1e, 1f, 1g. Thus, in the mobile communication system according to the invention, the information transmission device 3 is not an essential element; however, even when a small number of information transmission devices 3 serving as infrastructure are merely installed, communication quality thereof can be brought near the quality similar to an instance where a large number of ones are installed.

In the inter-vehicle communication network 100 shown in FIG. 1(a), the mobile communication device 2 of the vehicle 1 holds the distributed cache, and regularly updates the distributed cache by receiving/transmitting the distributed cache even when it is not requested by the mobile communication device 2 of the specific vehicle 1. In this way, the mobile communication devices 2 of the vehicles 1 located within the range of the inter-vehicle communication network 100 can update the distributed caches of the mobile communication devices of the respective vehicles 1 without causing a concentration of load on the mobile communication device 2 of the specific vehicle 1.

In the mobile communication system according to Embodiment 1 in the invention shown in FIG. 1(b), the mobile communication device 2d of the vehicle 1d does not directly request to the mobile communication device 2c of the vehicle 1c, but inquiries presence/absence of the distributed cache of the mobile communication devices 2 of the vehicles 1e, 1f, 1g constituting a group of vehicles, and receives the distributed cache from the mobile communication device 2 that holds the desired distributed cache. When all the distributed caches 102, 103, 104 constituting the original information 101 are received, all the distributed caches 102, 103, 104 are combined to restore and acquire the original information 101. In this manner, the mobile communication device 2 according to Embodiment 1 in the invention is able to distribute the original information to a large number of vehicles 1 without causing the concentration of load on the mobile communication device 2 of the specific vehicle 1. Therefore, the mobile communication device 2 according to Embodiment 1 in the invention is able to perform the load balancing of the communication traffic and to reduce the occurrence of a communication error even when large data communication is carried out.

In FIG. 1(a), the vehicle 1a goes out of the range of the inter-vehicle communication network 100 and the mobile communication device 2 of the vehicle 1a transmits a distributed cache to the vehicle 1b located outside the range of the inter-vehicle communication network 100, whereby the mobile communication device 2 of the vehicle 1b located outside the range of the inter-vehicle communication network 100 is also enabled to receive the distributed cache. Thus, the mobile communication device 2 of the vehicle 1b located outside the range of the inter-vehicle communication network 100 is also able to obtain the information within the inter-vehicle communication network 100.

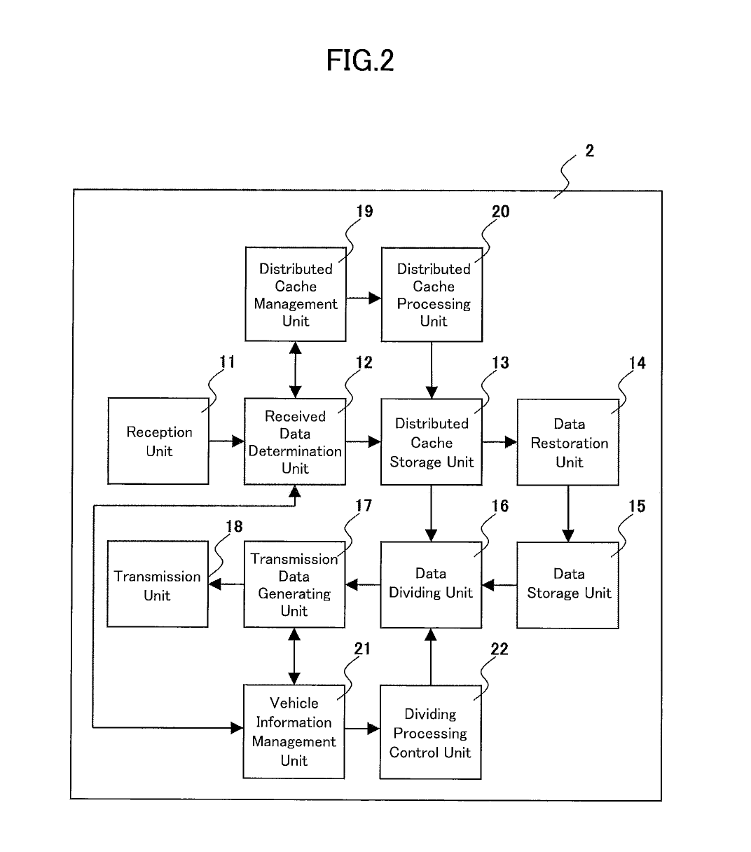

FIG. 2 is a block diagram showing the configuration of the mobile communication device according to Embodiment 1 in the invention.

The mobile communication device 2 mounted on the vehicle 1 includes: a reception unit 11 for receiving the data that is information or a distributed cache; a received data determination unit 12 for determining the data (information or the distributed cache) received by the reception unit 11; a distributed cache management unit 19 for managing the distributed cache; a distributed cache storage unit 13 for storing the distributed cache, a data restoration unit 14 for restoring original information from a plurality of distributed caches; and a distributed cache processing unit 20 for storing, deleting, merging, and correcting the distributed cache in the distributed cache storage unit 13. The distributed cache management unit 19 has holding management information for the distributed caches, and notifies the distributed cache processing unit 20 of the management information. The distributed cache processing unit 20 uses the management information provided by the distributed cache management unit 19 to store the distributed cache in the distributed cache storage unit 13, or delete, merge, or correct the distributed cache.

Further, the mobile communication device 2 includes: a data storage unit 15 for storing data other than distributed caches (restored original information, prestored information and the like); a data dividing unit 16 for dividing the corresponding information into the distributed caches; a transmission data generating unit 17 for adding thereto the header information including the information relating to a transmission source that is required for transmitting the distributed caches divided by the data dividing unit 16 to the external; a vehicle information management unit 21 for managing vehicle information (such as position, speed, time, traveling direction, surrounding vehicle information table (routing table) and so on); a dividing processing control unit 22 for controlling the dividing processing of the information performed by the data dividing unit 16 such as the data size of the distributed cache; and a transmission unit 18 for transmitting the distributed cache. The vehicle information management unit 21 notifies the transmission data generating unit 17 and the dividing processing control unit 22 of the information of the vehicle 1. The dividing processing control unit 22 controls the data dividing unit 16 by using the information of the vehicle 1 transmitted by the vehicle information management unit 21. The dividing processing control unit 22 controls the data dividing unit 16, for example, to reduce the dividing size when the speed is higher than a threshold, and to increase the dividing size when the speed is lower than the threshold.

The distributed cache storage unit 13 and the data storage unit 15 are constituted by a memory, while the other components are controlled by the program manipulation with a CPU (Central Processing Unit).

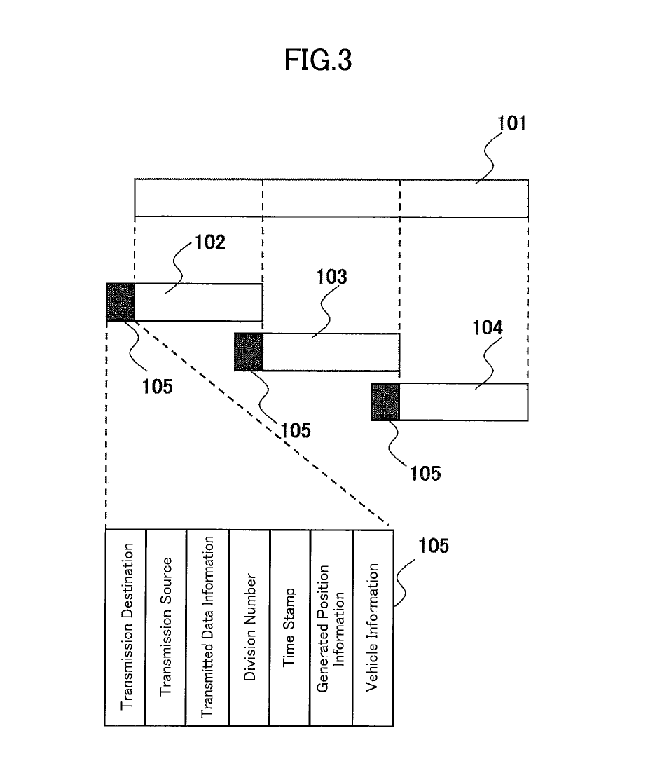

FIG. 3 is a configuration diagram showing the distributed caches transmitted/received between the mobile communication devices according to Embodiment 1 in the invention.

The original information 101 is divided into distributed caches 102, 103, 104 by the data dividing unit 16 of the mobile communication device 2. Header information 105 is added by the transmission data generating unit 17 to the headers of the divided distributed caches 102, 103, 104, and includes transmitted data information including transmission destination, transmission source, transmitted data length indicating the length of original information, transmitted data identifier and type of transmitted information, division number, time stamp indicating the time when the original information is generated, generated position information of the information, vehicle information, and so on. The transmitted data identifier is numeric information enabling the original information to be uniquely identified, and it may be, for example, a hash value of the transmission data with an MD5 (Message Digest 5) or the like. When the original information is divided into divided blocks, the division number is a serial number to be assigned from the head of the divided blocks: when the original information is divided into m blocks, the division number assigned to the n-th distributed cache is represented by n/m. In FIG. 3, the division number assigned to the distributed cache 102 is represented by 1/3, the division number assigned to the distributed cache 103 is represented by 2/3, and the division number assigned to the distributed cache 104 is represented by 3/3. The data restoration unit 14 restores the original information by combining a plurality of the distributed caches while using the transmitted data identifiers and the division numbers in the header information. The header information 105 may include the data length of each of the distributed cache.

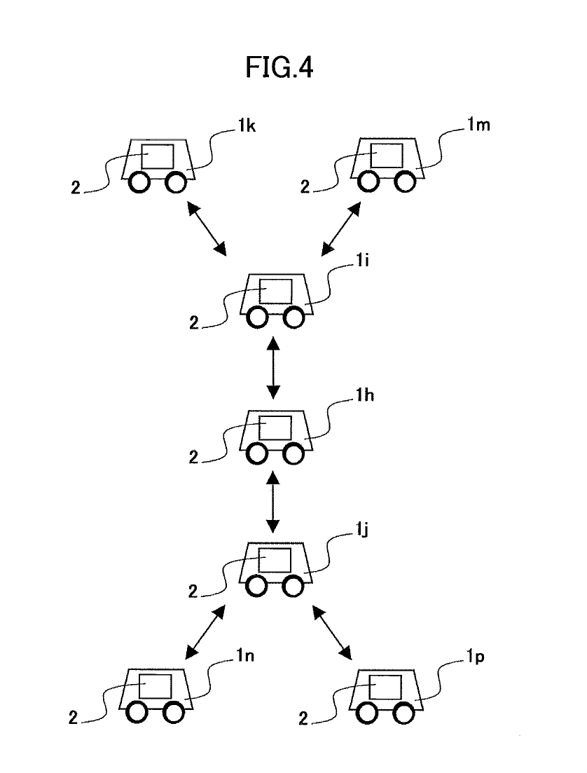

FIG. 4 is a schematic diagram showing a state of exchange of surrounding vehicle information in the mobile communication system according to Embodiment 1 in the invention.

The vehicle information management unit 21 of the mobile communication device 2 of each of vehicles 1h, 1i, 1j, 1k, 1m, 1n, 1p has a surrounding vehicle information table in which the information on the surrounding vehicles 1 is described. Table 1 below shows an example of the surrounding vehicle information table. In the surrounding vehicle information table, there are described vehicle title, IP address, time at which the vehicle participates in the inter-vehicle communication network 100, and number of arrival hops indicating the number of routers passing through before arriving at the relevant vehicle.

TABLE 1

| | | Participation | Number of |
|---|---|---|---|
| Title | IP address | time | arrival hops |
| Vehicle 1 | XXX.XXX.XXX.001 | Jan. 1, 2010 0:00 | 1 |
| Vehicle 2 | XXX.XXX.XXX.002 | Jan. 1, 2010 6:00 | 1 |

As shown in FIG. 4, before transmitting/receiving the distributed caches, the mobile communication devices 2 of the vehicles 1 transmit/receive the surrounding vehicle information possessed by the mobile communication device 2 of the vehicles 1 with the vehicles 1 adjacent by one hop via the respective transmission units 18 and reception units 11, and update their possessing surrounding vehicle information table by using the received surrounding vehicle information. Specifically, the vehicle 1h transmits the vehicle information of the vehicle 1h itself to the surrounding vehicles 1i and 1j. Also, the vehicle 1i transmits the vehicle information of the vehicle 1i itself to the surrounding vehicles 1h, 1k, 1m. Likewise, the vehicle 1j transmits the vehicle information of the vehicle 1j itself to the surrounding vehicles 1h, 1n, 1p. At this time, the vehicles 1h, 1i, 1j also transmit the vehicle information of the surrounding vehicles possessed by the vehicles themselves, together with the vehicle information of the vehicles themselves. The vehicle information to be transmitted may be, for example, the vehicle information of the surrounding vehicles located within one hop area.

The surrounding vehicle information transmitted/received by the mobile communication device 2 include the information (Hallo information) meaning that the relevant vehicle 1 participates in the inter-vehicle communication network 100. The header of the surrounding vehicle information may include header information 105 similar to the distributed cache, but excluding the division number. When the header information 105 similar to the distributed cache is added to the header of the surrounding vehicle information, the transmission destination may be set to a broadcast address so that the surrounding vehicle information is transmitted to all the vehicles 1 within the inter-vehicle communication network 100, and a special value (such as zero) may be set to the transmitted data information, meaning no data to transmit.

Thus, when the respective vehicles 1 carry out the transmission/reception of the surrounding vehicle information, all the vehicles 1 located within the inter-vehicle communication network 100 are allowed to share the vehicle information. It is noted that since the protocol (method) to transmit/receive the surrounding vehicle information is not restricted, any protocol such as AODV (Ad hoc On-Demand Distance Vector) or OLSR (Optimized Link State Routing) can be employed.

The mobile communication device 2 according to Embodiment 1 in the invention saves or deletes the received distributed cache according to a predetermined deletion condition.

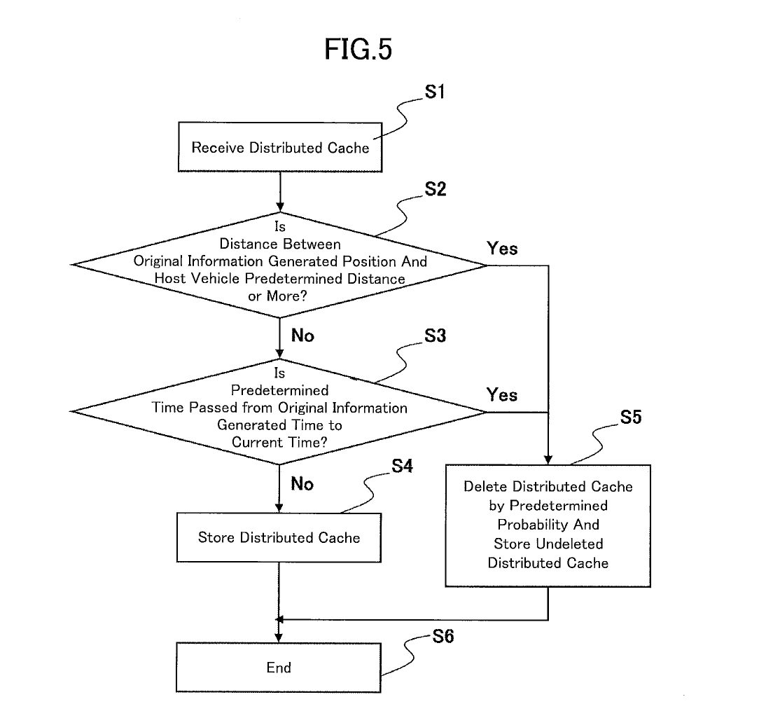

FIG. 5 is a flowchart showing the reception processing of the distributed cache in the mobile communication device according to Embodiment 1 in the invention.

When the reception unit 11 of the mobile communication device 2 receives a distributed cache in step S1, the received data determination unit 12 determines, in step S2, whether a distance between the original information generated position and the position of the host vehicle 1 at the current time (current position) is equal to or greater than a predetermined distance by referring to the generated position information (indicating the generated position of the original information) in the header information of the distributed cache and the position of the host vehicle 1 managed by the vehicle information management unit 21. When the distance between the original information generated position and the current position of the host vehicle 1 is equal to or greater than a predetermined distance, the processing proceeds to step S5; when the distance between the original information generated position and the current position of the host vehicle 1 is smaller than a predetermined distance, the processing proceeds to step S3. In step S3, the received data determination unit 12 determines whether or not the time passed from the original information generated time to the current time is equal to or greater than a predetermined time by referring to the time stamp of the header information of the distributed cache. When the time passed from the original information generated time to the current time is equal to or greater than a predetermined time, the processing proceeds to step S5, whereas when it is shorter than a predetermined time, the processing proceeds to step S4. In step S4, the distributed cache processing unit 20 stores the distributed cache in the distributed cache storage unit 13 and terminates the processing (step S6). In step S5, the distributed cache processing unit 20 deletes the distributed cache by a predetermined probability, while stores undeleted distributed cache in the distributed cache storage unit 13.

The information separated from the original information generated position by a predetermined distance or more, or the information passed by a predetermined time or more from the original information generated time has a higher possibility to be not useful at a position where the mobile communication device 2 receives the distributed cache. As described above, when the distance between the original information generated position and the current position of the host vehicle 1 is equal to or greater than a predetermined distance, or when the time passed from the original information generated time to the current time is equal to or greater than a predetermined time, the relevant distributed cache is deleted by a predetermined probability, whereby the storage area of the distributed cache storage unit 13 can be utilized more effectively. Further, the need of retransmitting the distributed cache is eliminated, and therefore an efficient use in communication zone can be realized.

When the distance between the position where the transmission source vehicle 1 transmits the received distributed cache and the current position of the vehicle 1 is equal to or greater than a predetermined distance, or when the time passed from the transmitted time of the distributed cache to the current time is equal to or greater than a predetermined time, the probability to delete the distributed cache may be more than 0% but not more than 100%, and preferably more than 0% and less than 100%.

In addition, in the present Embodiment 1, the deletion condition of the distributed cache is established in the following cases: the distance between the original information generated position of the received distributed cache and the current position of the vehicle 1 is equal to or greater than a predetermined distance, or the time passed from the original information generated time to the current time is equal to or greater than a predetermined time, the condition is not limited to this. Further, the deletion condition can be established by only either a case that the distance between the original information generated position of the received distributed cache and the current position of the host vehicle 1 is equal to or greater than a predetermined distance, or a case that the time passed from the original information generated time to the current time is equal to or greater than a predetermined time. Furthermore, the information of another transmission source may be referred to as the deletion condition.

Otherwise, the received data determination unit 12 may set two or more thresholds for the deletion condition to change the probability to delete. For example, when a first deletion condition is established such that the distance between the original information generated position of the received distributed cache and the current position of the host vehicle 1, or the time passed from the original information generated time of the received distributed cache to the current time is equal to or greater than a first threshold, the probability to delete the distributed cache is defined as a first probability. When a second deletion condition is established such that the distance between the original information generated position of the received distributed cache and the current position of the host vehicle 1, or the time passed from the original information generated time of the received distributed cache to the current time is less than the first threshold, but equal to or greater than a second threshold, that is, the distributed cache is considered more useful than the distributed cache meeting the first deletion condition, the probability to delete the distributed cache is defined as a second probability that is lower than the first probability. In such a way, the provision of two or more thresholds for the deletion condition makes it possible to realize both diffusion of useful information and effective utilization of the area of the storage (memory). However, the received data determination unit 12 may dynamically change the thresholds of the deletion conditions, for instance, based on the original information generated time.

Further, when the distributed cache has a type of transmission data as the transmitted data information, the received data determination unit 12 may determine to delete the distributed cache by changing the threshold according to the type of transmission data. Further, the received data determination unit 12 may change the probability to delete the distributed cache according to the type of transmission data. For example, for the information that is limited to a region, as compared with the information other than this, the threshold may be set to be smaller or the probability to delete may be set to be greater, and for the information such as sightseeing information that can be distributed over a wide area, as compared with the information other than this, the threshold may be set to be greater, or the probability may be set to be smaller.

Incidentally, although in the present Embodiment 1 the received data determination unit 12 determines upon receiving a distributed cache, whether the distributed cache is to be deleted or stored based on the deletion condition, the distributed caches stored in the distributed cache storage unit 13 may be periodically checked and deleted based on the deletion condition.

### Embodiment 2

In the mobile communication device according to Embodiment 1 in the invention, as an example of the deletion condition of the received data determination unit 12, there is illustrated an example using the distance between the position of the host vehicle 1 and the position of the another vehicle 1 that is the transmission source of the received distributed cache, or the time passed from the transmitted time of the received distributed cache to the current time. In a mobile communication device according to Embodiment 2 in the invention, as an example of the deletion condition of the received data determination unit 12, the speed and the traveling direction of the transmission source vehicle 1 of the distributed cache are used. The other configuration features and functions are the same as those of the mobile communication device according to Embodiment 1.

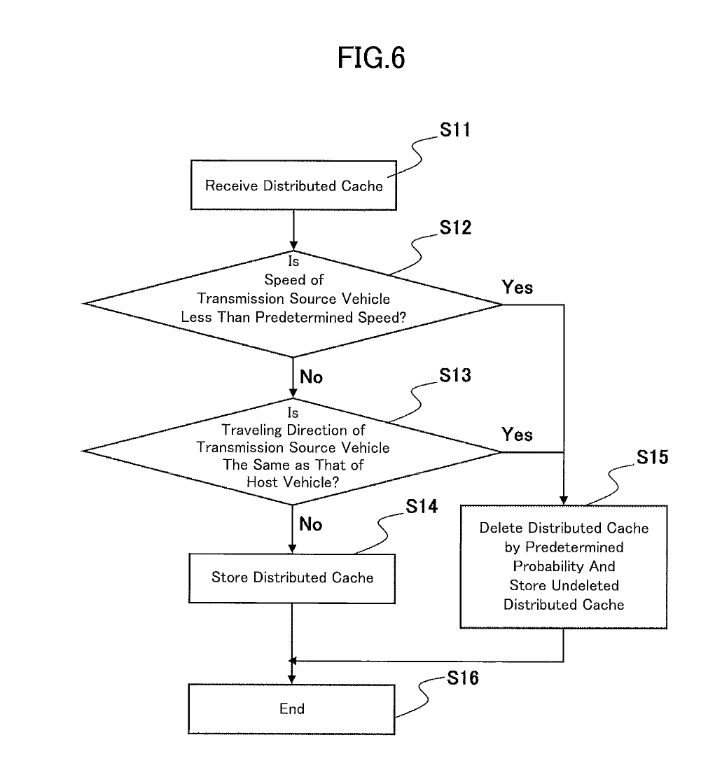

FIG. 6 is a flowchart showing the reception processing of the distributed cache in the mobile communication device according to Embodiment 2 in the invention.

When the reception unit 11 of the mobile communication device 2 receives a distributed cache in step S11, the received data determination unit 12 refers to, in step S12, speed information of vehicle information of the distributed cache (indicating the speed of the transmission source vehicle 1), to determine whether or not the speed of the transmission source vehicle 1 is less than a predetermined speed. When the speed of the transmission source vehicle 1 is less than a predetermined speed, the processing proceeds to step S15, whereas when the speed of the transmission source vehicle 1 is equal to or more than a predetermined speed, the processing proceeds to step S13. In step S13, the received data determination unit 12 refers to the traveling direction information of the vehicle information (indicating the traveling direction of the transmission source vehicle 1), and determines whether or not the traveling direction of the transmission source vehicle 1 is the same as the traveling direction of the host vehicle 1. When the traveling direction of the transmission source vehicle 1 is the same as the traveling direction of the host vehicle 1, the processing proceeds to S15, whereas when it is not the same as the traveling direction of the host vehicle 1, the processing proceeds to step S14. At this time, in step S14, the received data determination unit 12 may determine that the traveling direction of the host vehicle 1 is the same as the traveling direction of the transmission source vehicle 1, when an angle defined between the traveling direction of the host vehicle 1 and the traveling direction of the transmission source vehicle 1 is within a predetermined range of angle; and it may determine that the traveling direction of the vehicle 1 is not the same as the traveling direction of the host the vehicle 1, when the angle defined between the traveling direction of the transmission source vehicle 1 and the traveling direction of the host vehicle 1 is not within a predetermined range of angle. In step S14, the distributed cache processing unit 20 stores the distributed cache in the distributed cache storage unit 13. In step S15, the distributed cache processing unit 20 deletes the distributed cache by a predetermined probability, while storing undeleted distributed caches in the storage unit 13.

When the speed of the transmission source vehicle 1 is less than a predetermined speed or the traveling direction of the transmission source vehicle 1 is the same as the traveling direction of the host vehicle 1, it is highly possible that the mobile communication device 2 has already received information from the corresponding transmission source. Therefore, the mobile communication device 2 deletes the distributed cache when the speed of the transmission source vehicle 1 is less than a predetermined speed or the traveling direction of the transmission source vehicle 1 is the same as the traveling direction of the host vehicle 1, whereby the storage area of the distributed cache storage unit 13 can be utilized effectively. On the other hand, when the traveling direction of the transmission source vehicle 1 is not the same as the traveling direction of the host vehicle 1, it is highly possible that the other surrounding vehicles 1 also have not received the information from the transmission source. Therefore, the mobile communication device 2 is allowed to receive a new distributed cache by preferentially receiving information from the vehicle 1 traveling in an opposite direction to the host vehicle 1, whereby the diversity of the distributed cache stored in its own distributed cache storage unit 13 can be contemplated and utilization efficiency thereof can be improved.

It is noted that though in Embodiment 2 in the invention, both the speed and the traveling direction of the vehicle 1 are used as the deletion conditions, either one of them can be used as the deletion condition. Also, the storage or deletion of the distributed cache may be determined by combining the deletion condition of the distributed cache as described in Embodiment 1 and the deletion condition of the distributed cache as described in the Embodiment 2.

### Embodiment 3

In a mobile communication system according to Embodiment 3 in the invention, when a distributed cache is transmitted on an inter-vehicle communication network 100 in which an overlay network is established, the transmission destination thereof is determined on the basis of the priorities determined corresponding to the speeds of vehicles 1. The other configuration features and functions are the same as those of the mobile communication system described in Embodiment 1.

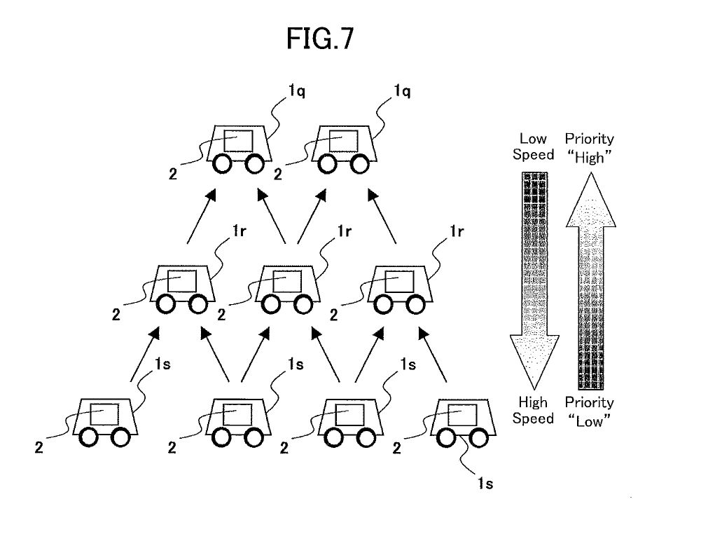

FIG. 7 is a schematic diagram showing a relationship between priority and transmission/reception of distributed caches in the mobile communication system according to Embodiment 3 in the invention.

In the mobile communication device 2 according to Embodiment 3 in the invention, the vehicle information management unit 21 establishes the surrounding vehicle information table, based on the speeds (absolute speeds relative to the ground) of the surrounding vehicles 1 in the surrounding vehicle information table, such that the vehicle 1 traveling at a lower speed is assigned with a higher priority, while a vehicle 1 traveling at a higher speed is assigned with a lower priority. In the mobile communication system shown in FIG. 7, the priority is categorized in three stages: vehicles 1q traveling at a speed lower than a first threshold speed are assigned with a “high” priority; vehicles 1r traveling at a speed equal to or higher than the first threshold speed but lower than a second threshold speed are assigned with a “medium” priority; and vehicles 1s traveling at a speed equal to or higher than the second threshold speed are assigned with a “low” priority. The transmission unit 18 of the mobile communication device 2 of each vehicle 1 transmits the distributed cache to the mobile communication device 2 of the vehicle 1 with a priority higher than that of the host vehicle 1, but does not transmit the distributed cache to the vehicle 1 with a priority lower than that of the host vehicle 1 or the vehicle 1 with a priority equivalent to that of the host vehicle 1.

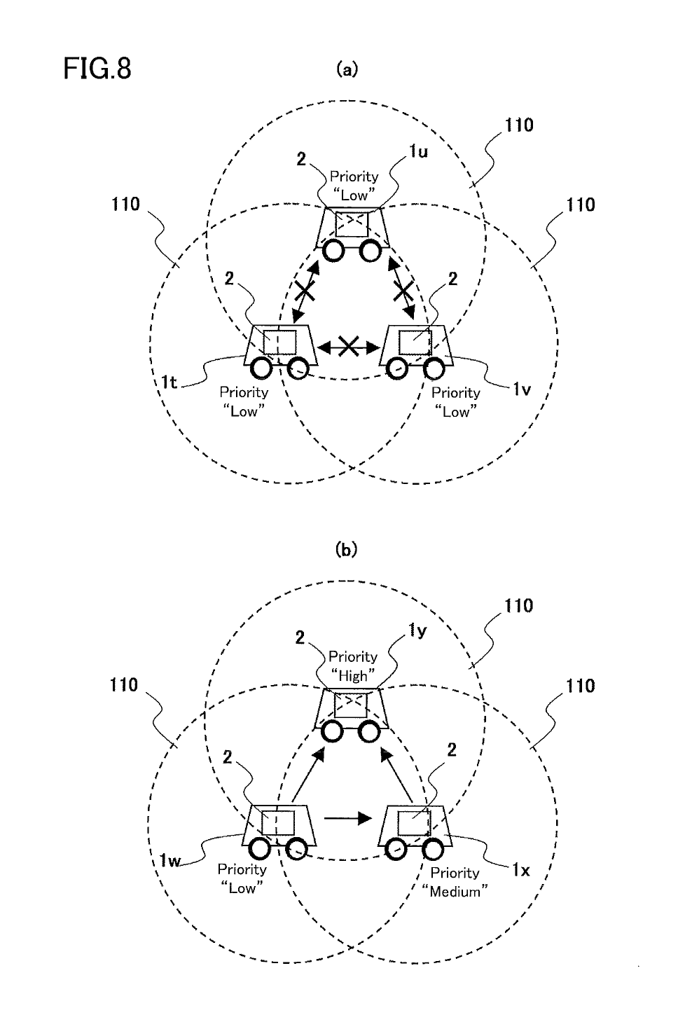

FIG. 8 is a schematic diagram showing the transmission/reception states of the distributed caches in the mobile communication system according to Embodiment 3 in the invention.

In FIG. 8(a), vehicles 1t, 1u, 1v with the “low” priority are located within their communication area 110. However, the vehicles 1t, 1u, 1v do not mutually transmit the distributed caches and suspend the transmission of the distributed caches, since the surrounding vehicles it, 1u, 1v located within the communication area 110 have the same priority as the host vehicle 1, and no vehicle having a higher priority than the host vehicles it, 1u, 1v is located within the communication area 110.

In FIG. 8(b), a vehicle 1w with the “low” priority, a vehicle 1x with the “medium” priority, and a vehicle 1y with the “high” priority are located within the communication area 110. The vehicle 1w with the “low” priority transmits the distributed cache to the vehicles 1x and 1y having the priority higher than the host vehicle 1w. The vehicle 1x having the “medium” priority transmits the distributed cache to the vehicle 1y having the priority higher than the host vehicle 1x, but does not transmits the distributed cache to the vehicle 1w having the priority lower than the host vehicle 1x. The vehicle 1y does not transmit the distributed cache to suspend the transmission of the distributed cache, since no vehicle with the priority higher than that of the host vehicle 1y is located within the communication area 110.

Each mobile communication device 2 according to Embodiment 3 in the invention transmits the distributed cache to the mobile communication device 2 of the vehicle 1 having the priority higher than the priority of the host vehicle 1. In other words, the distributed cache is transmitted to the vehicle 1 traveling at a lower speed than the host vehicle 1, and therefore, the holding amount of the distributed caches is the largest in the vehicle 1q traveling at a low speed and having the “high” priority, and is decreased in the order of the vehicle 1r traveling at a medium speed and having the “medium” priority, and the vehicle is traveling at a high speed and having the “low” priority. Further, in the mobile communication device 2 according to Embodiment 3 in the invention, the distributed cache is transmitted to the mobile communication device 2 of the vehicle 1 traveling at a lower speed than the host vehicle 1, which enables to prevent a plurality of distributed caches constituting original information from being dispersed geographically. Further, the transmission of the distributed caches as mentioned above can suppress the distributed caches not constituting the original information from being stored in the mobile communication device 2 of the vehicle 1, and hence prevent excessive load to the storage area of the distributed cache storage unit 13.

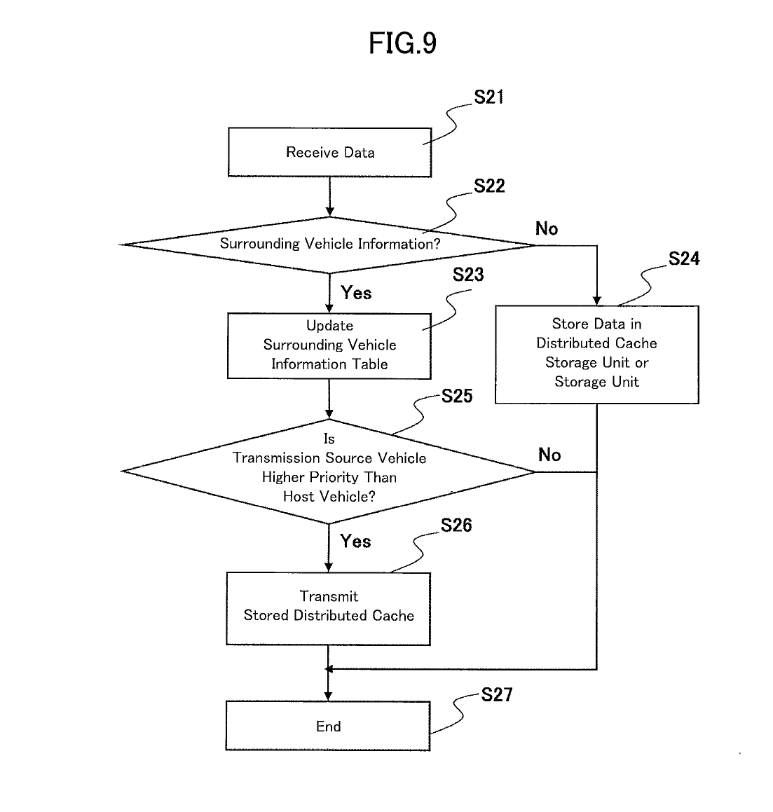

FIG. 9 is a flowchart showing the transmission/reception processing of the distributed caches in the mobile communication device according to Embodiment 3 in the invention.

When the reception unit 11 receives data in step S21 of FIG. 9, the received data determination unit 12 refers to a type of information in transmitted data information of header information, in step S22, and determines whether or not the received data is surrounding vehicle information. When the type of information is surrounding vehicle information, the processing proceeds to step S23, whereas when the type of information is not surrounding vehicle information, the processing proceeds to step S24. In step S24, data of a distributed cache is stored in the distributed cache storage unit 13, whereas data that is not a distributed cache is stored in the data storage unit 15 and the processing is ended (step S27).

In step S23, the vehicle information management unit 21 updates the surrounding vehicle information table held by itself based on the received surrounding vehicle information. When the surrounding vehicle information table is updated, the processing then proceeds to step S25; the received data determination unit 12 determines, based on the received surrounding vehicle information, whether or not the priority of the transmission source vehicle 1 is higher than the priority of the host vehicle 1. When the priority of the transmission source vehicle 1 is higher than the priority of the host vehicle 1, the processing proceeds to step S26; the distributed caches stored in the distributed cache storage unit 13 are transmitted to the transmission source of the surrounding vehicle information and the processing is ended (step S27). When the priority of the transmission source vehicle 1 is equal to or lower than the priority of the host vehicle 1, the processing proceeds to step S27 to be ended.

As described above, in the mobile communication device 2 according to Embodiment 3 in the invention, as soon as the vehicle 1 having a priority higher than that of the host vehicle 1 is found, the distributed cache stored in the distributed cache storage unit 13 of the mobile communication device 2 of the host vehicle 1 is transmitted to the corresponding vehicle, and thereby the distributed caches are transmitted periodically; thus, a system can be built up, which enables the vehicle 1 traveling at a low speed and having the high priority to hold the distributed caches in a concentrated manner while preventing congestion thereof.

It is noted that in the present Embodiment 3, the mobile communication device 2 determines the priority of each vehicle 1 according to its traveling speed, and determines whether or not a distributed cache is to be transmitted to the corresponding vehicle based on the priority thus determined; however, the mobile communication device 2 may determine to transmit the distributed cache directly based on the traveling speed of each vehicle 1 without determining the priority. Therefore, the mobile communication device 2 transmits the distributed cache when the traveling speed of the transmission source vehicle 1 is lower than the traveling speed of the host vehicle 1, whereas the mobile communication device 2 need not transmit the distributed cache when the traveling speed of the transmission source vehicle 1 is equal to or higher than the traveling speed of the host vehicle 1.

### Embodiment 4

In a mobile communication system according to Embodiment 4 in the invention, a distributed cache is transmitted through the use of a routing on the inter-vehicle communication network 100. The other configuration features and functions are the same as those of the mobile communication system of Embodiment 3.

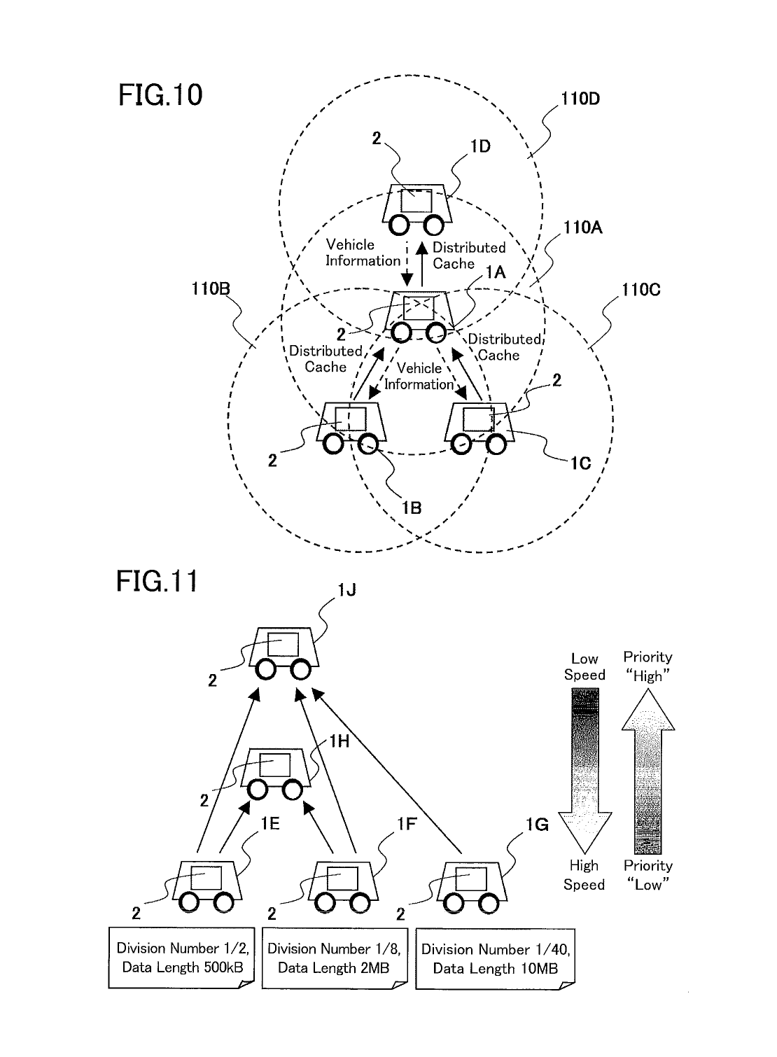

FIG. 10 is a schematic diagram showing a state of the transfer of the distributed caches in the mobile communication system according to Embodiment 4 in the invention.

In FIG. 10, vehicles 1B, 1C having a “low” priority and a vehicle 1D having a “high” priority are located within a communication area 110A of the vehicle 1A having a “low” priority. While the vehicle 1A and the vehicle 1C are located within a communication area 110B of the vehicle 1B, the vehicle 1D is not located in the communication area 110B of the vehicle 1B. Likewise, while the vehicles 1A and 1B are located within a communication area 110C of the vehicle 1C, the vehicle 1D is not located within the communication area 110C of the vehicle 1C. Therefore, the vehicle 1A is located within the communication area 110D of the vehicle 1D, whereas the vehicles 1B and 1C are not located within the communication area 110D of the vehicle 1D. Accordingly, neither the vehicle 1B nor the vehicle 1C can detect the presence of the vehicle 1D.

If the routing is not involved, as described in Embodiment 3, the vehicle 1B and the vehicle 1C suspend the transmission of the distributed caches since no vehicles having a priority higher than the host vehicles 1B, 1C are present within the communication areas 100B, 100C of the host vehicles 1B, 1C.

In the mobile communication system according to the present Embodiment 4, the mobile communication device 2 of the vehicle 1A transmits the surrounding vehicle information of the vehicle 1D to the vehicles 1B and 1C which are located within the communication area 110A of the host vehicle 1A. The received data determination units 12 of the mobile communication devices 2 of the vehicles 1B and 1C can recognize the presence of the vehicle 1D having a higher priority than the host vehicles 1B and 1C by receiving the surrounding vehicle information of the vehicle 1D from the mobile communication device 2 of the vehicle 1A. Thus, the transmission data generating units 17 of the mobile communication devices 2 of the vehicles 1B and 1C transmit the distributed caches to the vehicle 1A while designating the vehicle 1D having a priority higher than the host vehicles 1B, 1C as the transmission destination. Upon receiving the distributed caches from the vehicles 1B and 1C, the transmission unit 18 of the mobile communication device 2 of the vehicle 1A transfers the distributed caches to the vehicle 1D that is designated as the transmission destination.

An arbitrary protocol (method) such as routing AODV (Ad hoc On-Demand Distance Vector) or OLSR (Optimized Link State Routing) that is a routing protocol to be used in an ad hoc network can be used as the routing method.

As described above, in the mobile communication system according to Embodiment 4 in the invention, the mobile communication device 2 receives the surrounding vehicle information including the priorities of the vehicles 1 located outside the communication area 110 of the host vehicle 1 via the vehicle 1 located within the communication area 110 of the host vehicle 1. Upon receiving the surrounding vehicle information of the vehicle 1 located outside the communication area 110 of the host vehicle 1, the mobile communication device 2 transmits the distributed cache, with the routing, to the vehicle 1 located within the communication area 110 of the host vehicle 1 while designating the vehicle 1 located outside the communication area 110 of the host vehicle 1 and having a priority higher than the host vehicle 1 as the transmission destination. Therefore, the mobile communication device 2 described in Embodiment 4 is enabled to transmit/receive the distributed cache even when the vehicle 1 having a higher priority than the host vehicle 1 is located outside the communication area of the host vehicle 1.

It is noted that though in Embodiment 4 in the invention, the vehicle information management unit 21 of the mobile communication device 2 uses the traveling speed of the vehicle 1 to determine the priority thereof, it may use another information to determine the priority.

For example, the vehicle information management unit 21 of the mobile communication device 2 may store the time course of the time information and the position information of the surrounding vehicles received as the surrounding vehicle information, and may calculate a sojourn time of the surrounding vehicle 1 within a predetermined range. When the sojourn time is longer than a predetermined time, the possibility that the corresponding surrounding vehicle 1 stays within a predetermined range is high, and hence the priority of the corresponding surrounding vehicle 1 is set to “high”.

As described above, when the priority is determined, the priority can be set to high even for the vehicle 1 that travels at a low speed in average but momentarily travels at a high speed; thus, a system can be built up, which enables a vehicle 1 having a low traveling speed and a high priority to hold the distributed caches in a concentrated manner while preventing congestion thereof.

The vehicle information management unit 21 of the mobile communication device 2 according to Embodiment 4 in the invention may be configured to determine a fiducial value of the priorities with traveling speeds or the like of the vehicles 1 as described in Embodiment 3, and may further correct the fiducial value of the priorities with the traveling directions and so on of the vehicles 1. When the traveling direction of the surrounding vehicle 1 is the same as the traveling direction of the host vehicle 1, the priority is corrected to be higher, whereas when the traveling direction of the surrounding vehicle 1 is not the same as the traveling direction of the host vehicle 1, the priority is corrected to be lower. In general, the communication between the vehicles 1 traveling in the same direction is higher in successful probability than that between the vehicles 1 traveling in opposite directions.

As described above, the probability of a successful communication between vehicles 1 can be increased by determining a fiducial value of the priorities with traveling speeds and the like of the vehicles 1 and then correcting the fiducial value of the priorities with the traveling directions and the like of the vehicles 1, and thus the distribution efficiency of the distributed caches can be enhanced. Therefore, the communication band can be used efficiently.

It is noted that though in Embodiments 1 to 4, the mobile communication device 2 transmits/receives surrounding vehicle information before transmission/reception of the distributed cache, it may transmits/receives the surrounding vehicle information at the same time as transmission/reception of the distributed cache by inserting the surrounding vehicle information into apart of the distributed cache.

Further, although the mobile communication device 2 according to Embodiment 4 transfers the distributed cache to a single transfer destination, the transfer destination is not limited to one, and the mobile communication device 2 may transfer the distributed cache to a plurality of transfer destinations. In order to hold a plurality of transfer destinations, the mobile communication device 2 has only to be set so that a plurality of entries of the surrounding vehicle information table as described above can be maintained. When the vehicle 1 with the highest priority to be currently on transmission is shut down, the transfer destination is changed to the vehicle 1 with the next highest priority. It contributes to the strength of the communication to hold a plurality of transfer destinations for the mobile communication system that is mounted on the vehicle 1 and frequently shut down by going out of the communication area, which is preferable.

### Embodiment 5

In Embodiment 3, the priorities are determined with the traveling speeds of the vehicles 1, the priority of the transmission destination vehicle 1 is compared with the priority of the host vehicle 1, and the distributed cache is transmitted to the vehicle 1 having a higher priority than that of the host vehicle 1. In a mobile communication system according to Embodiment 5 in the invention, priorities are determined with the traveling speeds of vehicles 1 as in Embodiment 3, and it is determined whether or not a transmission is to be done by combining the priority and the data length of original information. The other configuration features and functions are the same as those of the mobile communication system according to Embodiment 3.

In the mobile communication system according to Embodiment 5 in the invention, distributed caches are transmitted to all of the vehicles 1 with priorities of “low”, “medium” and “high” when the data length of the original information is equal to or less than a first threshold data length. When the data length of the original information is greater than the first threshold data length but not greater than a second threshold data length, the distributed caches are transmitted to the vehicles 1 with the priorities of “medium” and “high”. Further, when the data length of the original information is greater than the second threshold data length, the distributed caches are transmitted only to the vehicles 1 with the priority of “high”.

FIG. 11 is a schematic diagram showing a relationship among the priority, data length, and transmission/reception of the distributed caches in the mobile communication system according to Embodiment 5 in the invention.

In FIG. 11, vehicles 1E, 1F, 1G traveling at a high speed and having the “low” priority hold distributed caches, respectively. In this example, each distributed cache has a fixed length of 250 kB. The distributed cache held by the vehicle 1E corresponds to a first block where the original information having a data length of 500 kB is divided into two blocks. The distributed cache held by the vehicle 1F corresponds to a first block where the original information having a data length of 2 MB is divided into eight blocks. The distributed cache held by the vehicle 1G corresponds to a first block in the case where the original information having a data length of 10 MB is divided into 40 blocks. Also, the vehicle 1H has a medium traveling speed and the “medium” priority, while the vehicle 1J has a low traveling speed and the “high” priority.

In this example, a first threshold data length is set to 500 KB and a second threshold data length is set to 2 MB. Therefore, the vehicle 1E holding a distributed cache whose original information has a data length that is not greater than the first threshold data length transmits the distributed cache to the vehicles 1F, 1G with the low priority, the vehicle 1H with the medium priority, and the vehicle 1J with the “high” priority, namely to the vehicles 1F, 1G, 1H, 1J of all the priorities. In addition, the vehicle 1F holding the distributed cache whose original information has a data length that is greater than the first threshold data length but not greater than the second threshold data length transmits the distributed cache to the vehicle 1H having the “medium” priority and the vehicle 1J having the high priority. The vehicle 1G holding the distributed cache whose original information has a data length that is greater than the second threshold data length transmits the distributed cache only to the vehicle 1J having the “high” priority.

The vehicles 1E, 1F, 1G traveling at a high speed and having the “low” priority cannot receive many distributed caches from a specific position. However, the vehicles 1E, 1F, 1G traveling at a high speed are more likely to move in a wide range than the vehicle 1J with the “high” priority and traveling at a low speed, and hence they are more likely to transport the distributed caches in a wide range. In other words, the vehicle 1J traveling at a low speed is less likely to move in a wide range than the vehicles 1E, 1F, 1G traveling at a high speed and less likely to transport the distributed cache in a wide range. However, the vehicle 1J traveling at a low speed is more likely to be located in a certain range and therefore enables the distributed cache to be localized within the range.

Accordingly, the received data determination unit 21 of the mobile communication device 2 according to Embodiment 5 in the invention determines whether or not the transmission is to be done by combining the priority based on the traveling speed of the vehicle 1 and the data length of the original information, whereby the exchange of the distributed caches between geographically remote positions is achieved, while the probability to restore the original information with the distributed caches held by the mobile communication devices 2 of the vehicles 1 can be maintained or improved.

It is note that the condition to combine the priority and the data length of the original information is not limited to the one described above. Also, as the condition to determine the priority, the position may be employed instead of the speed; based on a distance from a predetermined position, the priority can be determined, such that the vehicle 1 located at a small distance is assigned with a high priority, while the vehicle 1 located at a large distance is assigned with a low priority. Further, the thresholds are not limited to the above.

### Embodiment 6

In the mobile communication like the inter-vehicle communication network 100, it is important to improve the efficiency of the power consumption and communication band. In general, the power consumption is increased when the transmission rate becomes higher. On the other hand, when the transmission loss ratio is high, the transmission rate is increased to transmit more information; thus, the communication band is used by the transmission of useless information, which leads to the deterioration of the efficiency of the whole mobile communication system. In a mobile communication device 2 according to Embodiment 6 in the invention, the transmission rate is changed based on the density of surrounding vehicles 1. When the transmission loss ratio is high, the transmission rate is decreased to thus reduce the power consumption while relaxing the compression of the communication band. The other configuration features and functions are the same as those of the mobile communication system according to Embodiment 1.

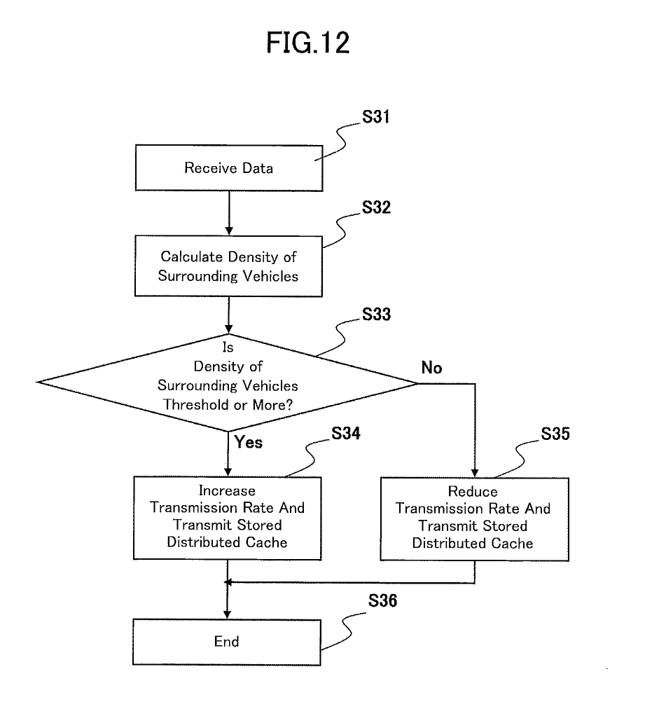

FIG. 12 is a flowchart showing the changing procedure of the transmission rate in the mobile communication device according to Embodiment 6 in the invention.

When a reception unit 11 of the mobile communication device 2 receives a distributed cache in step S31, a received data determination unit 12 refers to, in step S32, position information in vehicle information (indicating the position of a transmission source vehicle) in the received distributed cache, and calculates the density of the surrounding vehicles 1 based on the position of the transmission source vehicle 1 and the positions of the surrounding vehicles 1 obtained from the vehicle information previously received. At this point, the range for calculating the density of the vehicles 1 may be a predetermined range, or the communication area under the current circumstances, or a range that is dynamically varied based on random numbers or the like.

Next, in step S33, the received data determination unit 12 determines whether or not the density of the surrounding vehicles is equal to or higher than a threshold density. When the density of the surrounding vehicles is equal to or higher than the threshold density, the processing proceeds to step S34, whereas the density of the surrounding vehicles is lower than the threshold density, the processing proceeds to step S35. In step S34, the transmission unit 18 increases the transmission rate upon transmitting the distributed cache by a predetermined ratio from a predetermined transfer rate, transmits the distributed cache stored in the distributed cache storage unit 13 to the transmission source, and ends the processing (step S36). Also, in step S35, the transmission unit 18 decreases the transmission rate upon transmitting the distributed cache by a predetermined ratio from a predetermined transfer rate, transmits the distributed cache stored in the distributed cache storage unit 13 to the transmission source, and ends the processing (step S36). The ratio in which the transmission unit 18 increases or decreases the transmission rate may be a fixed value or may be dynamically changed based on the speed of the host vehicle 1 or a radio wave condition such as noise level in the transmission frequency band.

As described above, when the density of the surrounding vehicles is high, the mobile communication device according to Embodiment 6 in the invention increases the transmission rate, since the distance between the vehicles 1 is short and hence the transmission loss ratio is low. In contrast, when the density of surrounding vehicles is low, the transmission rate is decreased, since the distance between the vehicles 1 is great and hence the transmission loss ratio is high. This makes it possible to reduce the power consumption of the mobile communication device 2 by concentrating the transmission when the transmission loss ratio is low, and to efficiently make use of the communication band of the mobile communication system.

It is noted that though in Embodiment 6, the density of the surrounding vehicles is calculated based on the position information in the vehicle information of the distributed cache, the density of the surrounding vehicles may be calculated based on the position information contained in the surrounding vehicle information. Further, although in Embodiment 6, the density of the surrounding vehicles is calculated based on the position information in the vehicle information, another method can be employed instead. For example, the received data determination unit 12 may calculate a density of the surrounding vehicles by storing a surrounding vehicle counter, and then incrementing the surrounding vehicle counter by one when the distributed cache or the surrounding vehicle information is received from the surrounding vehicle 1 and the reception of the distributed cache or the surrounding vehicle information is the first time from the corresponding vehicle 1.

Further, the invention may be embodied by combining Embodiments in the invention.

### EXPLANATION OF REFERENCE NUMERALS

1 Vehicle; 2 Mobile communication device; 3 Information transmission device; 11 Reception unit; 12 Received data determination unit; 13 Distributed cache storage unit; 14 Data restoration unit; 15 Data storage unit; 16 Data dividing unit; 17 Transmission data generating unit; 18 Transmission unit; 19 Distributed cache management unit; 20 Distributed cache processing unit; 21 Vehicle information management unit; 22 Dividing processing control unit; 100 Mobile communication network; 101 Original information; 102, 103, 104 Distributed cache; 105 Header information; 110 Communication area.

1. A mobile communication device mounted on a vehicle and comprising:
a reception unit for receiving a distributed cache that is data having divided information;
a data restoration unit for restoring into original information the distributed cache;
a data dividing unit for producing the distributed cache by dividing the information; and a transmission unit for transmitting the distributed cache.

2. The mobile communication device according to claim 1, comprising:
a received data determination unit for determining whether or not the distributed cache is to be deleted based on the information relating to a transmission source attached to the distributed cache; and
a distributed cache processing unit for deleting the distributed cache by a predetermined probability based on a determination result of the received data determination unit.

3. The mobile communication device according to claim 2, wherein the information relating to the transmission source is the position, the speed, or the traveling direction of the vehicle of the transmission source of the distributed cache, or a transmission time thereof.

4. The mobile communication device according to claim 2, wherein the received data determination unit deletes the distributed cache by a predetermined probability, when a distance between the position of the transmission source vehicle at the transmitted time of the distributed cache and the current position of a host vehicle is equal to or greater than a predetermined distance.

5. The mobile communication device according to claim 2, wherein the received data determination unit deletes the distributed cache by a predetermined probability, when the time from the transmitted time of the distributed cache to the current time is equal to or more than a predetermined time.

6. The mobile communication device according to claim 2, wherein the received data determination unit deletes the distributed cache by a predetermined probability, when the speed of the transmission source vehicle of the distributed cache is lower than a predetermined speed.

7. The mobile communication device according to claim 2, wherein the received data determination unit deletes the distributed cache by a predetermined probability, when the traveling direction of the transmission source vehicle of the distributed cache is within a predetermined range with respect the traveling direction of a host vehicle.

8. The mobile communication device according to claim 1, comprising a received data determination unit for determining whether or not the distributed cache is to be transmitted to the vehicle based on a priority assigned to the vehicle, wherein when the received data determination unit determines that the distributed cache is to be transmitted, the transmission unit transmits the distributed cache to the vehicle.

9. The mobile communication device according to claim 1, comprising a received data determination unit for determining whether or not the distributed cache is to be transmitted to the vehicle based on the speed, the position, or the traveling direction of the vehicle, the data length of original information, or a transmitted time of the information,
wherein when the received data determination unit determines that the distributed cache is to be transmitted, the transmission unit transmits the distributed cache to the vehicle.

10. The mobile communication device according to claim 1, comprising a transmission data generating unit for designating a transmission destination for the distributed cache,
wherein the transmission data generating unit designates the vehicle existing outside a communication area of the host vehicle as a transmission destination of the distributed cache, and the transmission unit transmits the distributed cache to the vehicle existing within the communication area of the host vehicle.

11. The mobile communication device according to claim 1, wherein the transmission unit changes the transmission rate upon transmitting the distributed cache based on the density of surrounding vehicles.
